(19) United States
(12) Patent Application Publication
(10) Pub. No.: US 2007/0239630 A1
(43) Pub. Date: Oct. 11, 2007

(54) Method and system for allowing multiple applications to utilize customized feedback with a shared machine learning engine

(75) Inventors: John Sidney Davis, New York, NY (US); Daby Mousse Sow, White Plains, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/363,238

(22) Filed: Feb. 28, 2006

(51) Int. Cl. G06F 15/18

(52) U.S. Cl. 706/12

(57) ABSTRACT

A method (and system) of using a machine learning infrastructure to support the learning requirements of a plurality of goal-oriented applications includes instantiating a machine learning infrastructure that includes a plurality of learning algorithms with an interface to the algorithms, and registering a plurality of goal-oriented applications with the machine learning infrastructure

### BACKGROUND OF THE INVENTION

1. Field of the Invention

The present invention relates to the support of multiple data mining applications by a machine learning engine and, more particularly, to data mining applications that mine data about users.

2. Description of the Related Art

Collecting and determining patterns of user data in order to customize the functionality of an application on a user's behalf is a common goal among many classes of applications. Examples of user data include location of the user, temperature of the environment in which the user is located, the state of executing software or hardware being used by the user, as well as many other forms of environmental information. A user is generally a human, although a user may also be a machine, such as a computer or personal digital assistant (PDA).

There is a recent trend toward employing data in order to provide some benefit to a user. For instance, global positioning system (GPS) data can be analyzed to determine if a user is leaving or will soon arrive home. Based on the data, the user's home thermostat can be adjusted so that the temperature will be appropriate for cost savings if the user's home is vacant, or comfortable for the user if the user will soon arrive home. An application that leverages data, in this fashion must be customized to individual user needs. Different users have different notions about what constitutes a comfortable temperature or what leads to a reasonable assumption that a user is traveling home. User data employed in this manner is often called “context” and applications employing the data are often called “context-aware applications.”

A common technique for customizing functionality based on user data is to apply machine learning or statistical algorithms to the user data and to provide user feedback to these algorithms to account for variability. The implementation necessary to support this kind of system is an expensive process. Machine learning algorithms are difficult to understand, and feedback mechanisms involve knowledge of signal processing that is non-trivial. Further, many context-aware applications require machine learning and feedback support, and there is currently no known mechanism for multiple context-aware applications to share a common machine learning and feedback infrastructure.

### SUMMARY OF THE INVENTION

In view of the foregoing and other exemplary problems, drawbacks, and disadvantages of the conventional methods and structures, an exemplary feature of the present invention is to provide a method and system which provides feedback support for a machine learning infrastructure for supporting a multitude of goal-oriented applications for a multitude of users in which the users have distinct data characteristics.

In an exemplary aspect of the present invention, two goal-oriented applications will be registered with a machine learning infrastructure. Two or more users will be registered with the machine learning infrastructure such that each of the goal-oriented applications has two users registered to use the application. Both applications will work on the registered users' behalf by determining patterns of user activity (i.e., patterns of data about the users). As the applications execute, patterns of data will be determined for each user and feedback data will be collected from both users and fed into a feedback mechanism. The feedback data will scale each user's feedback according to the requirements of the associated application. Upon future observations of a given user's patterns, the applications will be appropriately initiated based on a scale triggered from the observed data. As user data is collected, the feedback mechanism will automatically determine the best learning algorithm for each user/application pair according to the characteristics of each user's data.

In a first exemplary aspect of the present invention, a method of using a machine learning infrastructure to support the learning requirements of a plurality of goal-oriented applications, includes instantiating a machine learning infrastructure that includes a plurality of learning algorithms with an interface to the algorithms, and registering a plurality of goal-oriented applications with the machine learning infrastructure.

In a second exemplary aspect, the method according to the first aspect preferably further includes registering a plurality of users with the machine learning infrastructure, wherein each of the registered goal-oriented applications is associated with at least one registered user.

In a third exemplary aspect, the method according to the second aspect preferably further includes generating at least one pattern for each user with the machine learning infrastructure for each of the goal-oriented applications.

In a fourth exemplary aspect, in the method according to the first aspect, the machine learning infrastructure preferably includes a single reinforcement learning feedback facility for the machine learning infrastructure.

In a fifth exemplary aspect, the method according to the first aspect preferably further includes associating each of the goal-oriented applications with a learning classification.

In a sixth exemplary aspect, the method according to the fifth aspect preferably further includes grouping the goal-oriented applications according to the associated learning classifications, and transforming the grouped goal-oriented applications into a common list.

In a seventh exemplary aspect, the method according to the sixth aspect preferably further includes using values of the goal-oriented applications according to the common list to route information into a reinforcement learning facility of the machine learning infrastructure.

In an eighth exemplary aspect, the method according to the second aspect preferably further includes automatically determining a best learning algorithm to apply for each relevant pair of the registered users and applications.

In a ninth exemplary aspect, in the method according to the first aspect the machine learning infrastructure preferably includes a single machine learning middleware infrastructure.

In a tenth exemplary aspect of the invention, a signal-bearing medium tangibly embodying a program of machine-readable instructions executable by a digital processing apparatus performs the method according to the first aspect.

In an eleventh exemplary aspect of the invention, a method of using a machine learning infrastructure to support a plurality of goal-oriented applications, includes instantiating a machine learning infrastructure comprising a machine learning algorithm, wherein the plurality of goal-oriented applications simultaneously use the machine learning algorithm.

In an twelfth exemplary aspect, the method according to the eleventh aspect preferably further includes registering the plurality of goal-oriented applications with the machine learning infrastructure.

In a thirteenth exemplary aspect, the method according to the eleventh aspect preferably further includes registering a plurality of users with the machine learning infrastructure, wherein each of the goal-oriented applications is associated with at least one registered user.

In a fourteenth exemplary aspect, the method according to the thirteenth aspect preferably further includes generating a pattern for each user with the machine learning infrastructure for each of the goal-oriented applications.

In a fifteenth exemplary aspect, the method according to the eleventh aspect preferably further includes grouping the goal-oriented applications according to learning classifications associated with each of the goal oriented applications, and transforming the grouped goal-oriented applications into a common list.

In a sixteenth exemplary aspect, the method according to the fifteenth aspect preferably further includes using values of the goal-oriented applications according to the common list to route information into the machine learning algorithm of the machine learning infrastructure.

In a seventeenth exemplary aspect of the invention, a system for using a machine learning infrastructure to support a plurality of goal-oriented applications, including a machine learning engine, the plurality of goal-oriented applications being registered with the machine learning engine, wherein the machine learning engine includes a pattern recognition unit that identifies patterns in an event log based on the plurality of goal-oriented applications.

In a eighteenth exemplary aspect, the system according to the seventeenth aspect preferably further includes a data aggregation unit that aggregates event data received from a plurality of data sources and generates the event log based on the event data received from the data sources.

In a nineteenth exemplary aspect, the system according to the eighteenth aspect preferably further includes a pattern matching unit that receives event data from the data aggregation unit, compares the received event data with the patterns identified by the machine learning engine, and initiates execution of one of the goal-oriented applications upon correlation of the received event data with a pattern identified by the machine learning engine to be associated with one of the goal-oriented applications.

In a twentieth exemplary aspect, the system according to the eighteenth aspect preferably further includes a feedback unit that receives feedback data regarding the goal-oriented application initiated by the pattern matching unit and updates the pattern associated with the goal-oriented application based on the feedback data.

These and other aspects of the present invention provide a method and system which provides feedback support for a machine learning 10 infrastructure for supporting a multitude of goal-oriented applications for a multitude of users in which the users have distinct data characteristics. As such, the present invention allows multiple users of a machine learning system to share a common feedback utility such that each user can provide individual feedback to result in individual algorithm improvements for that user.

Additionally, by providing a method and system permitting multiple context-aware applications to share a common machine learning and feedback infrastructure, the present invention obviates the need for developers of applications to have knowledge of machine learning algorithms and feedback mechanisms. Further, since the machine learning system supports multiple users and applications, these and other aspects of the present invention permit the amortization of costs associated with the implementation and use of machine learning systems.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 is an illustration of an exemplary application programmer interface axis for characterizing the machine learning algorithm that can be applied to a given application based on the application's event characteristics;

FIG. 2 is a block diagram illustrating a shared feedback system, according to an embodiment of the present invention;

FIG. 3 is a block diagram of an exemplary API for classifying applications that require machine learning algorithms;

FIG. 4 is a flow diagram illustrating the steps for registering an application, according to an embodiment of the present invention;

FIG. 5 is a flow diagram illustrating a methodology for registering an application to a machine learning algorithm, according to an embodiment of the present invention;

FIG. 6 is a flow diagram illustrating a method for arbitrating between similarly classified applications, according to an embodiment of the present invention;

FIG. 7 is a flow diagram for processing received user feedback and managing patterns of context data, according to an embodiment of the present invention;

FIG. 8 illustrates an exemplary hardware/information handling system 800 for incorporating the present invention therein; and

FIG. 9 illustrates an exemplary signal bearing medium 900 (e.g., storage medium) for storing steps of a program of a method according to the present invention.

### DETAILED DESCRIPTION OF EXEMPLARY EMBODIMENTS OF THE INVENTION

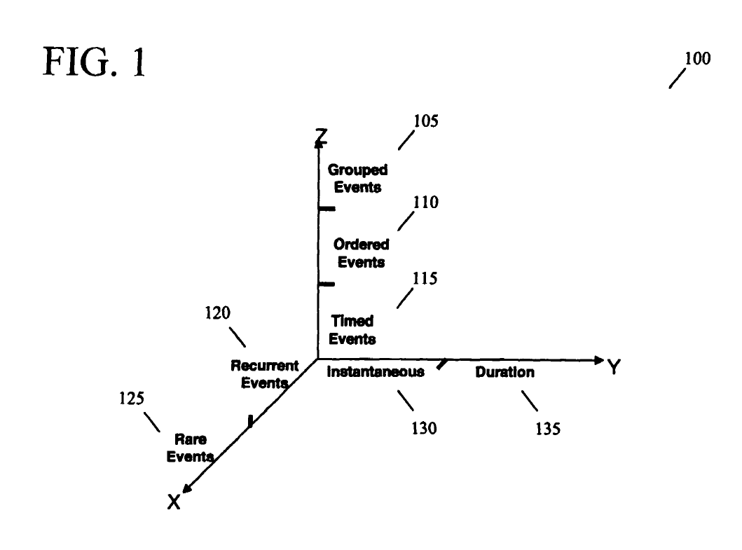

Referring now to the drawings, and more particularly to FIGS. 1-9, there are shown exemplary embodiments of the method and structures according to the present invention.

### Exemplary Embodiment

The present invention deals with machine learning and more specifically user feedback associated with systems that use machine learning. Machine learning is an area of computer science in which patterns can be automatically derived from sets of data so that future data observations will result in automated inferences. The goal of a machine learning-based system is to avoid the rigidity of rule based programming while making a user feel that a system is providing a customized response. In order to make the responses and inferences seem truly customized, user feedback is often employed. User feedback allows a user to indicate the validity of a machine learning system's output. This validity is fed back into the system as observed data for tuning the system's algorithm.

With the increasing ubiquity of computers, applications of machine learning are becoming more and more common. To amortize the costs of machine learning systems, it makes sense for a machine learning system (e.g., a single machine learning system in an exemplary embodiment) to support multiple users. In such a system, each user still needs to register feedback to improve the accuracy of the system algorithms. The present invention considers a method and system for allowing multiple users of a machine learning system to share a common feedback utility such that each user can provide individual feedback to result in individual algorithm improvements for that user.

It is to be understood that while the present invention will be described below in terms of illustrative task types, the invention is not so limited. Rather, the invention is more generally applicable to any tasks and task attributes with which it would be desirable to provide improved task management techniques that are based on context. As used herein, the term “context” is generally understood to refer to information about the physical or virtual environment of the user and/or a computational device that is being used by the user. Accordingly, pervasive, context-aware computing may be considered the process of automatically observing and making inferences on behalf of a user about environmental data from disparate sources. Recent advances in sensor technology technology as the development of widely accepted networking protocols enable the widespread emergence of pervasive, context-aware computing applications. Such applications leverage user context to form inferences about users.

FIG. 1 displays an exemplary classification of applications based on three dimensions. The X dimension considers whether events are “recurrent” 120 or “rare” 125. Recurrent 120 events result in patterns describing repetitive activities. In contrast, rare 125 events are anomalies or deviations from normal activities.

The Z dimension addresses the relationship between events within a pattern. A pattern that simply treats its events as the elements of a set falls into the category of grouped event 105. Patterns in which events are partially ordered fall in the ordered event 110 category. If events are totally ordered and the absolute start time of each event is important, then the appropriate category is timed event 115.

The Y dimension considers the length of each event. If an event is conceptually instantaneous (e.g., a web page request), then its position in the Y dimension is instantaneous 130. If the event has a nonzero duration (e.g., “going home”), then it falls within the duration 135 category along the Z dimension.

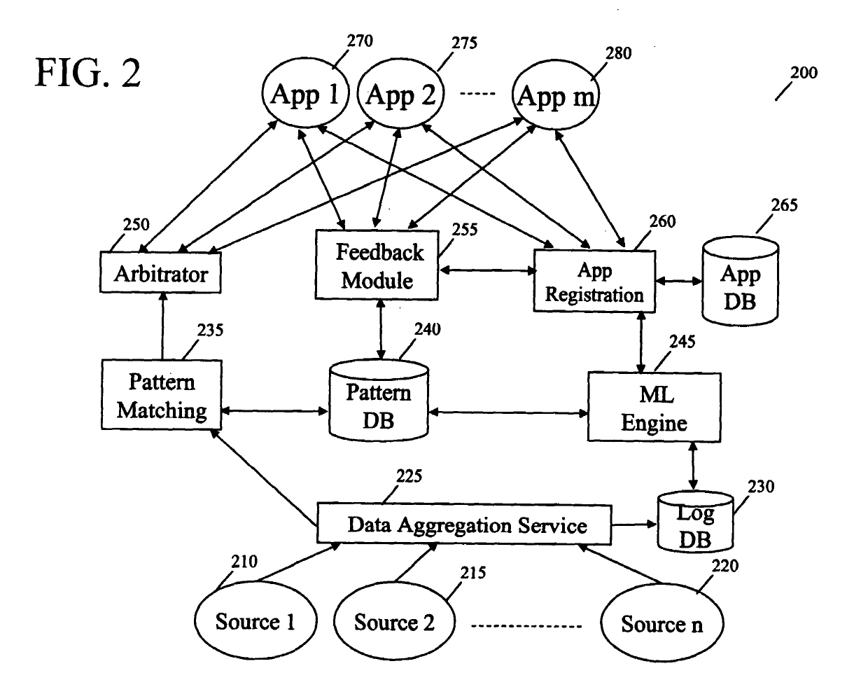

Referring now to FIG. 2, a block diagram of the general architecture for an exemplary embodiment of the method is shown. Data sources 210, 215, and 220 are pumping data into the system. Examples of data sources include user location, user instant messenger status, user phone status (on or off the hook), etc. The data aggregation service 225 receives and aggregates all data sent by the data sources 210, 215, 220. Logs of all contextual events are generated by the data aggregation service 225 and stored in a log database (DB) 230.

A machine learning (ML) engine 245 applies pattern recognition algorithms on the logs stored in the log DB 230 and generates patterns that are stored in the pattern DB 240. The type of patterns identified by the ML engine is dictated by the applications that are registered in the system.

In FIG. 2, m applications, (app1 (270), app2 (275) . . . app m (280)) are shown registered in the system. These applications interact with the App Registration module 260 to store their registrations in the App DB 265. The ML engine can then query the App Registration module 260 to obtain the list of applications registered in the system together with their learning requirements.

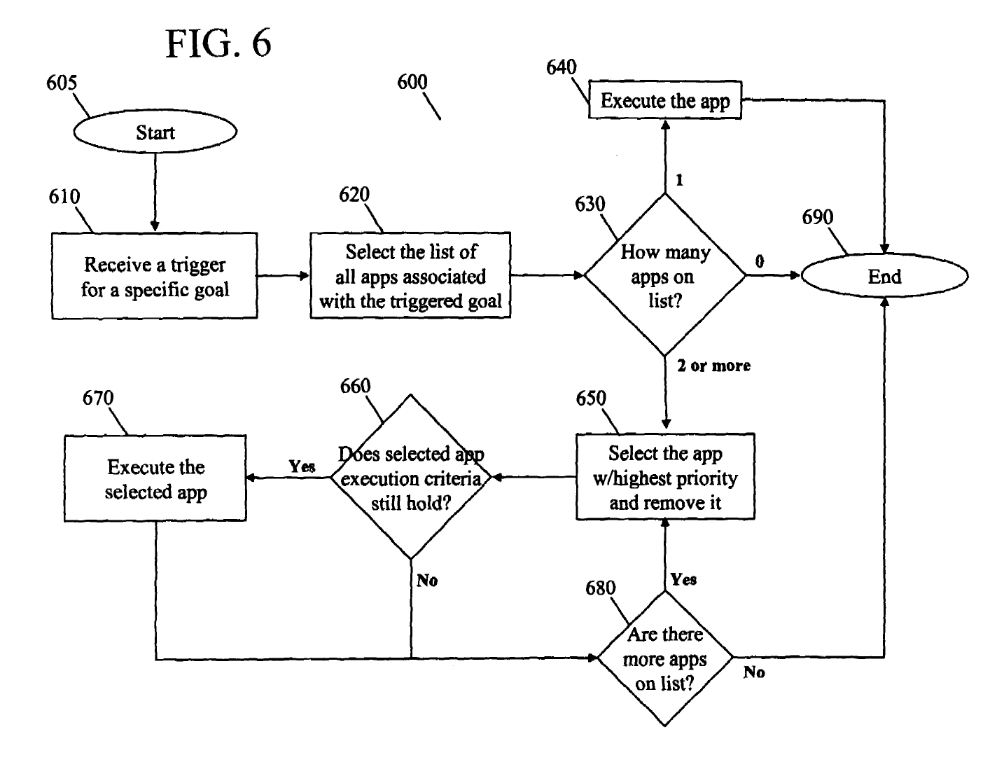

At runtime, the pattern matching module 235 loads the patterns stored in the pattern DB 240 and subscribes to events with the data aggregation service 225. Upon reception of events, the pattern matching module 235 determines whether there are patterns that should fire an action (e.g. initiate the execution of an application). If so, then it fires the corresponding actions to the arbitrator 250. The arbitrator 250 monitors the state of the applications (270,275,280) and schedules the delivery of these actions to the applications (270, 275, 280) in an intelligent manner that avoids conflicts. Details about this process are shown in FIG. 6 and described below.

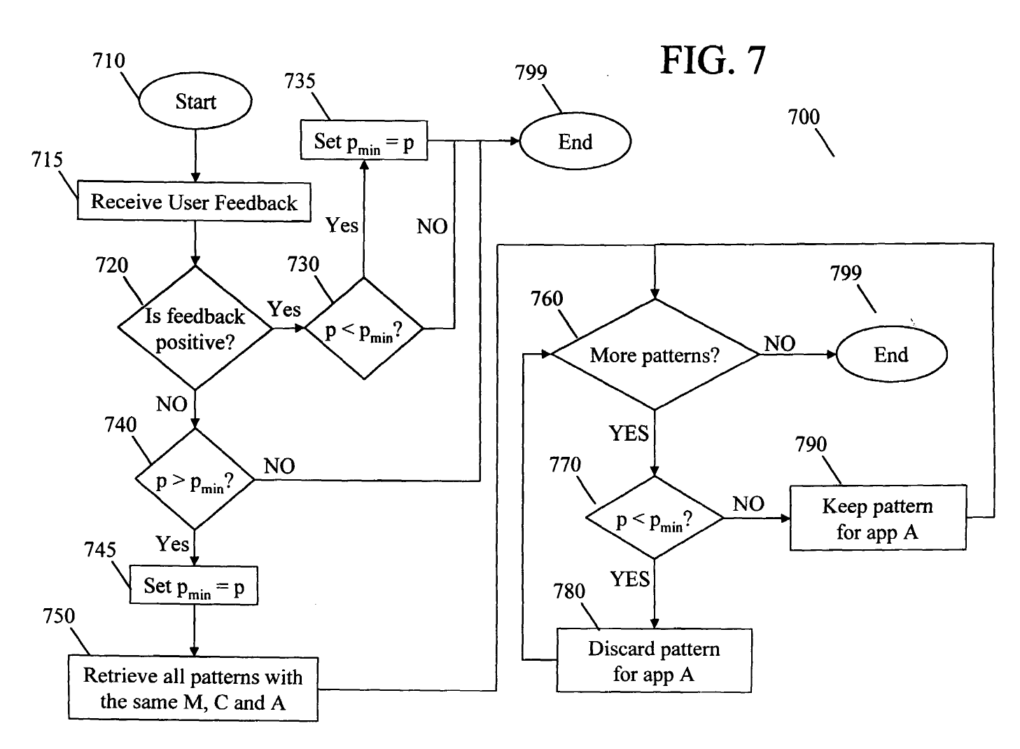

Finally, at runtime, users may send feedback to the predictions made by the systems through the corresponding applications (270, 275, 280). This feedback is captured by the feedback module 255. From this feedback, the feedback module 255 updates the corresponding patterns in the pattern DB 240. This process is explained in FIG. 7 and described below.

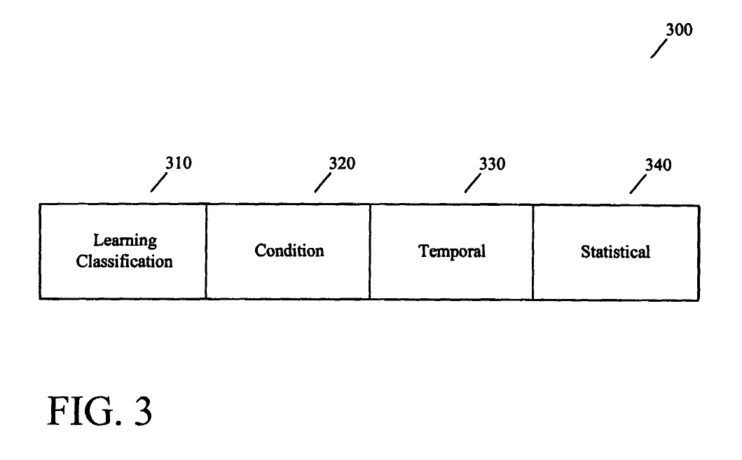

FIG. 3 describes an exemplary application classification application programming interface (API). Conceptually, there are four aspects of this API: the learning classification 310, the condition 320, the temporal 330, and statistical components 340.

The learning classification 310 is used to specify in which part of the axis API (see FIG. 1) to which the application belongs. The condition 320 of the API includes a developer-specified condition representing a simple event that must occur in order to signal the need for triggering of applications. The system correlates condition events with precondition events using its ML infrastructure. The developer-specified condition events should apply to a large set of users whereas the precondition events are often unique to individual users.

The temporal 330 component includes several parameters depending on whether the condition (precondition) events are timed, ordered or grouped. If the events are timed, then the temporal specification should indicate the duration of the predicted event. The temporal specification should also indicate how accurate in time the prediction should be as well as the minimum frequency in time of the predicted event. A lead time is indicated in the temporal specification to determine how far in advance the prediction should be made once the appropriate precondition is recognized. The statistical 340 component of the subscription defines the minimal likelihood and support that the applications need to be successful.

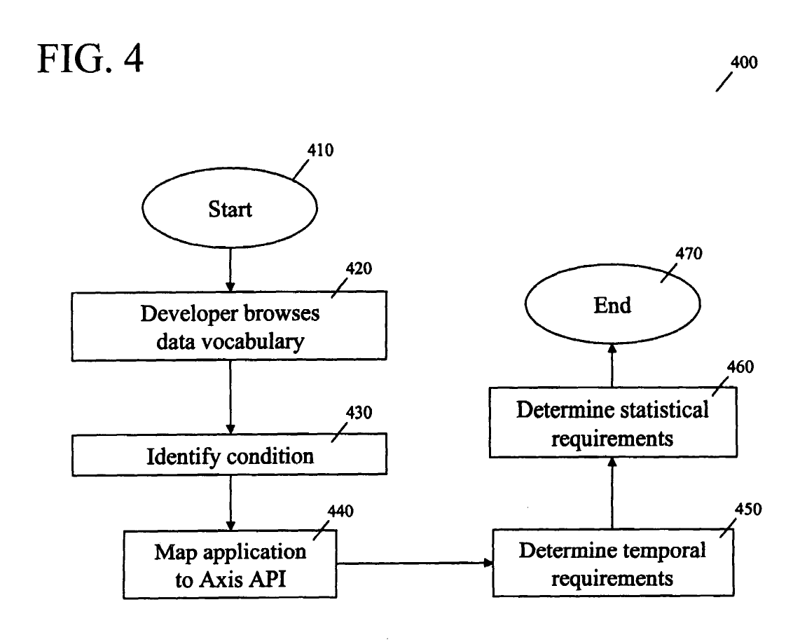

FIG. 4 is a flow diagram illustrating the steps a developer may take for registering an application, according to an embodiment of the present invention. An application developer begins (step 410) the registration process by browsing (step 420) a data vocabulary including contextual data to be used as triggering conditions. The developer identifies a triggering condition (step 430). Based on the triggering condition, the developer determines the position (step 440) of the application on the application axes exemplarily shown in FIG. 1. The developer specifies the temporal requirements (step 450) and the statistical requirements (step 460) after which the procedure concludes (step 470).

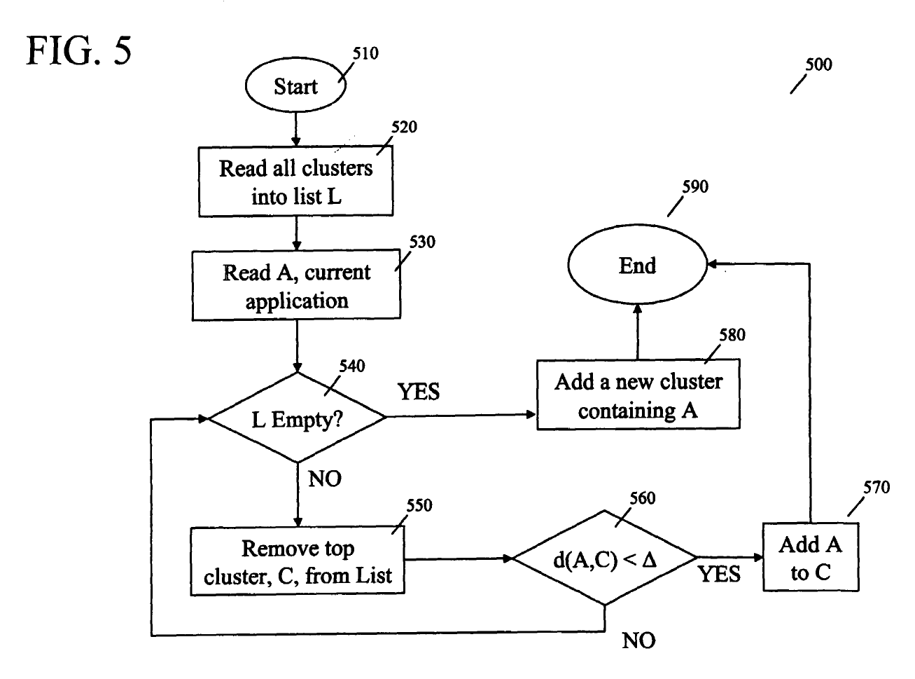

FIG. 5 is a flow diagram illustrating a methodology for associating an application with a machine learning algorithm, according to an embodiment of the present invention. The present invention stores clusters of applications according to the exemplary axes of FIG. 1.

The procedure (step 500) for associating applications with ML algorithms starts (step 510) by first reading all pre-determined clusters (step 520) into a list L. The current application to be associated with the ML algorithm is read (step 530). If the list L is empty (step 540) then a new cluster is created and the application is placed in this cluster (step 580). If the list L is not empty (step 540) then one of the clusters, C, is removed from the list L (step 550). The distance between the application A and the cluster C, based on their respective positions within the API axes, is measured and compared (step 560) against a predetermined threshold A, which may be set by the developer during registration of the application. Such a measurement is believed to be well-known to one of ordinary skill in the art. If the distance is greater than Δ, then the algorithm continues with step (step 540). If the distance is less than Δ, then the application A is added (step 570) to the cluster C and the algorithm ends (step 590).

FIG. 6 is a flow diagram illustrating a method for arbitrating between similarly classified applications, according to an embodiment of the present invention.

The execution starts (step 605) with the reception of a trigger for a specific goal (step 610). From this goal, the system queries and retrieves the list of all applications awaiting triggers for this goal (step 620). The size of the list is then tested (step 630).

If the list is empty, then the execution of this procedure ends (step 690) since there are no applications to notify. If the list contains only one application, then the identified application is executed (step 640) and the execution of the procedure ends (step 690). The more interesting cases are the ones that occur when there is more than one application registered in the system.

If there are two or more applications in the list, the algorithm selects the application with the highest priority (step 650) according to an arbitrary priority scheme. It removes the highest-priority application from the list (step 650). It then re-verifies if the selection criteria that triggered this goal is still valid (step 660). This step is useful since contextual conditions triggering patterns may be rapidly changing. If the selection criterion is still valid, then the selected application is executed (step 670) and it is checked if there are more applications in the list (step 680). If the selection criterion is not valid anymore, then the process proceeds to (step 680) to check if there are more applications in the list. If there are no more applications in the list, then the execution of this procedure (step 690) is ended. If there are more applications in the list, then the process reverts to (step 650) to select and remove from the list the application with the next highest priority.

FIG. 7 is a flow diagram for processing received user feedback and managing patterns of context data, according to an embodiment of the present invention.

When an application is triggered on a user's behalf according to a pattern of data collected about the user, the user feedback algorithm is started (step 710). In the present embodiment, user feedback may be Boolean having a value of either positive or negative. User feedback for a given application instance is collected (step 715) and determination is made as to whether the feedback is positive or negative (step 720). If positive feedback is received, then the algorithm checks the probability, p, of the pattern and compares it with the minimum probability, pₘᵢₙ (Step 730). If p is less than pₘᵢₙ, then pₘᵢₙ is set to p (Step 735) and ends the algorithm (step 799). If p is greater than or equal to pₘᵢₙ, then the algorithms ends (Step 799). If negative user feedback is received, then the probability, p, is compared with pₘᵢₙ again (Step 740). If p is less than or equal to pₘᵢₙ, then the algorithms ends (Step 799). If p is greater than pₘᵢₙ, then pₘᵢₙ is set to p (Step 745).

All patterns associated with the triggered application (A), condition (C) and ML algorithm (M) are then retrieved (step 750). For each retrieved pattern (Step 760), the corresponding probability of the selected pattern, p, is compared to the new minimum probability, pₘᵢₙ, previously determined in step 745. If p is greater than or equal to pₘᵢₙ (step 770), then the pattern p continues to be associated with the application (step 790) and the algorithm tests if there are more patterns that needs to be processed (Step 760). If p is less than pₘᵢₙ (step 770), then the pattern p is discarded and is no longer associated with the application (step 780) and a determination is then made as to whether all the patterns retrieved in step 750 have been processed (step 760). Upon determination that all the retrieved patterns have been processed, the algorithm ends (step 799).

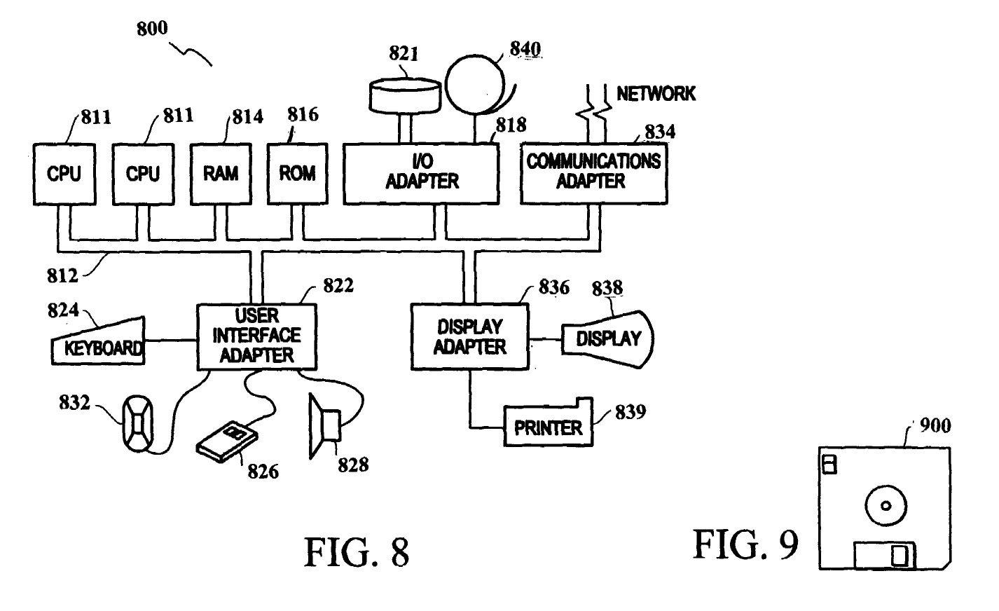

FIG. 8 illustrates a typical hardware configuration of an information handling/computer system in accordance with the invention and which preferably has at least one processor or central processing unit (CPU) 811.

The CPUs 811 are interconnected via a system bus 812 to a random access memory (RAM) 814, read-only memory (ROM) 816, input/output (I/O) adapter 818 (for connecting peripheral devices such as disk units 821 and tape drives 840 to the bus 812), user interface adapter 822 (for connecting a keyboard 824, mouse 826, speaker 828, microphone 832, and/or other user interface device to the bus 812), a communication adapter 834 for connecting an information handling system to a data processing network, the Internet, an Intranet, a personal area network (PAN), etc., and a display adapter 836 for connecting the bus 812 to a display device 838 and/or printer 839 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 811 and hardware above, to perform the method of the invention.

This signal-bearing media may include, for example, a RAM contained within the CPU 811, as represented by the fast-access storage for example. Alternatively, the instructions may be contained in another signal-bearing media, such as a magnetic data storage diskette 900 (FIG. 9), directly or indirectly accessible by the CPU 811.

Whether contained in the diskette 900, the computer/CPU 811, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, for example compiled from a language such as “C”, etc.

Additionally, in yet another aspect of the present invention, it should be readily recognized by one of ordinary skill in the art, after taking the present discussion as a whole, that the present invention can serve as a basis for a number of business or service activities. All of the potential service-related activities are intended as being covered by the present invention.

These and other aspects of the present invention provide a method and system which provides feedback support for a machine learning infrastructure for supporting a multitude of goal-oriented applications for a multitude of users in which the users have distinct data characteristics. As such, the present invention allows multiple users of a machine learning system to share a common feedback utility such that each user can provide individual feedback to result in individual algorithm improvements for that user.

Additionally, by providing a method and system permitting multiple context-aware applications to share a common machine learning and feedback infrastructure, the present invention obviates the need for developers of applications to have knowledge of machine learning algorithms and feedback mechanisms. Further, since the machine learning system supports multiple users and applications, these and other aspects of the present invention permit the amortization of costs associated with the implementation and use of machine learning systems.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method of using a machine learning infrastructure to support the learning requirements of a plurality of goal-oriented applications, the method comprising:
instantiating a machine learning infrastructure that includes a plurality of learning algorithms with an interface to said algorithms; and
registering a plurality of goal-oriented applications with said machine learning infrastructure.

2. The method of claim 1, further comprising:
registering a plurality of users with said machine learning infrastructure, wherein each of said registered goal-oriented applications is associated with at least one registered user.

3. The method of claim 2, further comprising:
generating at least one pattern for each user with said machine learning infrastructure for each of said goal-oriented applications.

4. The method of claim 1, wherein said machine learning infrastructure comprises a single reinforcement learning feedback facility for said machine learning infrastructure.

5. The method of claim 1, further comprising:
associating each of said goal-oriented applications with a learning classification.

6. The method of claim 5, further comprising:
grouping said goal-oriented applications according to said associated learning classifications; and
transforming said grouped goal-oriented applications into a common list.

7. The method of claim 6, further comprising:
using values of said goal-oriented applications according to said common list to route information into a reinforcement learning facility of said machine learning infrastructure.

8. The method of claim 2, further comprising:
automatically determining a best learning algorithm to apply for each relevant pair of said registered users and applications.

9. The method of claim 1, wherein said machine learning infrastructure comprises a single machine learning middleware infrastructure.

10. A signal-bearing medium tangibly embodying a program of machine-readable instructions executable by a digital processing apparatus to perform the method of claim 1.

11. A method of using a machine learning infrastructure to support a plurality of goal-oriented applications, the method comprising:
instantiating a machine learning infrastructure comprising a machine learning algorithm, wherein said plurality of goal-oriented applications simultaneously use said machine learning algorithm.

12. The method of claim 11, further comprising:
registering said plurality of goal-oriented applications with said machine learning infrastructure.

13. The method of claim 11, further comprising:
registering a plurality of users with said machine learning infrastructure, wherein each of said goal-oriented applications is associated with at least one registered user.

14. The method of claim 13, further comprising:
generating a pattern for each user with said machine learning infrastructure for each of said goal-oriented applications.

15. The method of claim 11, further comprising:
grouping said goal-oriented applications according to learning classifications associated with each of said goal oriented applications; and
transforming said grouped goal-oriented applications into a common list.

16. The method of claim 15, further comprising:
using values of said goal-oriented applications according to said common list to route information into said machine learning algorithm of said machine learning infrastructure.

17. A system for using a machine learning infrastructure to support a plurality of goal-oriented applications, comprising:
a machine learning engine, said plurality of goal-oriented applications being registered with said machine learning engine,
wherein said machine learning engine comprises a pattern recognition unit that identifies patterns in an event log based on said plurality of goal-oriented applications.

18. The system of claim 17, further comprising:
a data aggregation unit that aggregates event data received from a plurality of data sources and generates said event log based on said event data received from said data sources.

19. The system of claim 18, further comprising:
a pattern matching unit that receives event data from said data aggregation unit, compares said received event data with said patterns identified by the machine learning engine, and initiates execution of one of said goal-oriented applications upon correlation of said received event data with a pattern identified by said machine learning engine to be associated with said one of said goal-oriented applications.

20. The system of claim 19, further comprising:
a feedback unit that receives feedback data regarding said one of said goal-oriented applications initiated by said pattern matching unit and updates said pattern associated with said one of said goal-oriented applications based on said feedback data.
